(19) United States
(12) Patent Application Publication
(10) Pub. No.: US 2023/0294806 A1
(43) Pub. Date: Sep. 21, 2023

(54) WATERCRAFT MANEUVERING SYSTEM, AND WATERCRAFT INCLUDING THE WATERCRAFT MANEUVERING SYSTEM

(71) Applicant: YAMAHA HATSUDOKI KABUSHIKI KAISHA, Iwata-shi (JP)

(72) Inventors: Naoju TAKANO, Shizuoka (JP); Makoto ITO, Shizuoka (JP)

(21) Appl. No.: 18/120,449

(22) Filed: Mar. 13, 2023

(30) Foreign Application Priority Data
Mar. 15, 2022 (JP) 2022-040091

(51) Int. Cl. B63C 9/00; B63H 21/21; B63H 23/30; B63H 23/06; G05D 1/00; G05D 1/02

(52) U.S. Cl. CPC B63C 9/0011; B63H 21/21; B63H 23/06; B63H 23/30; G05D 1/0016; G05D 1/0022; G05D 1/0206; B63H 2021/216

(57) ABSTRACT

A watercraft maneuvering system includes an overboard sensor to detect an operator overboard event when a watercraft operator falls overboard from a watercraft, and a controller provided on the watercraft and configured or programmed to control a propulsion system of the watercraft. The controller is configured or programmed to perform a fixed point holding control operation to control the propulsion system to maintain a fixed position of the watercraft when the overboard sensor detects the operator overboard event. The overboard sensor is provided on the watercraft, and includes a communicator that wirelessly communicates with an operator fob to be carried by the operator. The operator sensor may detect the operator overboard event based on a state of communication between the operator fob and the communicator.

### CROSS REFERENCE TO RELATED APPLICATIONS

This application claims the benefit of priority to Japanese Patent Application No. 2022-040091 filed on Mar. 15, 2022. The entire contents of this application are hereby incorporated herein by reference.

### BACKGROUND OF THE INVENTION

### 1. Field of the Invention

The present invention relates to a watercraft maneuvering system and a watercraft including the watercraft maneuvering system.

### 2. Description of the Related Art

US 2020/0255104A1 discloses a wireless lanyard system that detects a watercraft operator falling overboard from a watercraft by utilizing wireless communications between a transceiver provided in a helm area of the watercraft and an operator fob carried by the operator. Such an operator overboard event is detected when the operator fob does not return a response signal in response to a query signal periodically transmitted by the transceiver. In response to the detection of the operator overboard event, the engine rotation speed of the watercraft is reduced to an idling rotation speed, and the gear system of the watercraft is shifted to a neutral position such that the generation of a propulsive force is stopped.

### SUMMARY OF THE INVENTION

The inventor of preferred embodiments of the present invention described and claimed in the present application conducted an extensive study and research regarding a watercraft maneuvering system, such as the one described above, and in doing so, discovered and first recognized new unique challenges and previously unrecognized possibilities for improvements as described in greater detail below.

When the operator overboard event is detected, the generation of the propulsive force by the propulsion system of the watercraft is stopped such that the watercraft is substantially prevented from moving away from the operator who has fallen overboard. However, the watercraft is inevitably moved by disturbances such as tidal currents and winds around the watercraft such that a distance between the overboard operator and the watercraft is liable to increase.

Preferred embodiments of the present invention provide watercraft maneuvering systems that are each able to substantially prevent an increase of a distance between a watercraft and a watercraft operator who has fallen overboard, and watercraft including such watercraft maneuvering systems.

In order to overcome the previously unrecognized and unsolved challenges described above, a preferred embodiment of the present invention provides a watercraft maneuvering system which includes an operator fob to be carried by an operator of a watercraft, an overboard sensor, provided on the watercraft and including a communicator to wirelessly communicate with the operator fob, to detect an operator overboard event based on a state of communication between the operator fob and the communicator, and a controller provided on the watercraft and configured or programmed to control a propulsion system of the watercraft. The controller is configured or programmed to perform a fixed point holding control operation to control the propulsion system so as to maintain the watercraft at a fixed position when the overboard sensor detects the operator overboard event.

With this arrangement, the controller performs the fixed point holding control operation when the operator carrying the operator fob falls overboard and the overboard sensor detects this overboard event. Thus, the propulsion system is controlled so as to maintain the watercraft at the fixed position such that the movement of the watercraft is substantially prevented. Therefore, a distance between the watercraft and the overboard operator is less liable to increase so that the overboard operator is able to easily return to the watercraft.

In a preferred embodiment of the present invention, if the overboard sensor detects the operator overboard event, the controller is configured or programmed to perform a deceleration control operation to control the propulsion system to decelerate the watercraft, and to perform the fixed point holding control operation after the deceleration control operation. With this arrangement, upon the detection of the operator overboard event, the watercraft is decelerated, and then the fixed point holding control operation is performed. Therefore, the watercraft is smoothly decelerated, and then is maintained at the fixed position.

In a preferred embodiment of the present invention, the propulsion system includes an engine, a propeller to be driven by the engine, and a clutch provided in a power transmission path between the engine and the propeller. The controller may be configured or programmed to perform the deceleration control operation if the overboard sensor detects the operator overboard event and, after the deceleration control operation, to move the clutch to a disengaged state, and then to perform the fixed point holding control operation.

With this arrangement, the propulsion system is an engine propulsion system including the engine (internal combustion engine). After the deceleration control operation, the clutch is brought into the disengaged state such that the watercraft is smoothly decelerated and then is brought into a propulsive force non-generatable state. Then, the movement of the watercraft is substantially prevented by the fixed point holding control operation.

Specifically, the deceleration control operation is performed to reduce the rotation speed of the engine, and the engine rotation speed is preferably reduced at a deceleration rate that provides the smooth deceleration of the watercraft.

An example of the clutch is a shift mechanism (typically, a gear mechanism) including a plurality of shift positions including a forward shift position, a neutral shift position, and a reverse shift position. When the shift position is the forward shift position, the propeller generates the propulsive force in a forward watercraft drive direction. When the shift position is the reverse shift position, the propeller generates the propulsive force in a reverse watercraft drive direction. When the shift position is the neutral shift position, the shift mechanism is brought into the disengaged state in which the power transmission path is cut off. Therefore, the power of the engine is not transmitted to the propeller.

In a preferred embodiment of the present invention, the controller includes a communicator to communicate with the operator fob. The operator fob includes a cancellation operation input operable by the operator (although another person may actually operate it depending on the circumstances), and a transmitter to transmit a fixed point holding cancellation command to the communicator of the controller according to an operation of the cancellation operation input. If the communicator of the controller receives the fixed point holding cancellation command from the operator fob, the controller is configured or programmed to stop the fixed point holding control operation.

With this arrangement, the operator is able to stop the fixed point holding control operation by remote control with the use of the operator fob according to a situation. Specifically, the operator who has fallen overboard may determine that stopping the fixed point holding control operation makes it difficult to increase the distance between the watercraft and the operator, or makes it easier for the operator to return to the watercraft. Therefore, the operator is able to select the continuation or the stopping of the fixed point holding control operation by remote control according to the situation. Thus, the operator is able to easily return to the watercraft.

The communicator of the controller may double as the communicator of the overboard sensor, or may be a communicator different from the communicator of the overboard sensor.

In a preferred embodiment of the present invention, the controller includes a communicator to communicate with the operator fob. The operator fob includes a watercraft maneuvering operation input operable by the operator (although another person may actually operate it depending on the circumstances), and a transmitter to transmit a watercraft maneuvering command to the communicator of the controller according to an operation of the watercraft maneuvering operation input. If the communicator of the controller receives the watercraft maneuvering command from the operator fob, the controller is configured or programmed to control the propulsion system so as to change one or both of the position and the azimuth of the watercraft according to the watercraft maneuvering command.

With this arrangement, the operator is able to control the propulsion system by remote control with the use of the operator fob such that the position and/or the azimuth of the watercraft is changed. Therefore, the operator who has fallen overboard with the operator fob is able to properly set the distance between the watercraft and the operator and/or the azimuth of the watercraft according to the situation. For example, the overboard operator is able to move the watercraft by remote control with the use of the operator fob so as not to increase the distance between the operator and the watercraft or so as to reduce the distance between the operator and the watercraft. Further, for example, the overboard operator is able to change the azimuth of the watercraft by remote control with the use of the operator fob so as to easily return to the watercraft.

In a preferred embodiment of the present invention, the watercraft maneuvering command is operable to change one or both of a target position and a target azimuth for the fixed point holding control operation. With this arrangement, the position and/or the azimuth of the watercraft is able to be changed by utilizing the function of the fixed point holding control operation, so that a remote watercraft maneuvering function is provided without complicating the control operation to be performed by the controller for remote control by the operator fob.

In a preferred embodiment of the present invention, the controller includes a communicator to communicate with the operator fob to transmit watercraft maneuvering information of the watercraft to the operator fob. The operator fob includes a receiver to receive the information transmitted from the communicator of the controller, and an notifier to provide the information received by the receiver to the operator.

With this arrangement, the watercraft maneuvering information of the watercraft is provided to the operator via the operator fob by the communication with the operator fob. Therefore, even if the operator is spaced away from a watercraft maneuvering area, for example, the operator is able to know the watercraft maneuvering information of the watercraft. Thus, the watercraft maneuvering system permits flexible behavior of the operator with regard to the watercraft.

In a preferred embodiment of the present invention, the information to be transmitted to the operator fob by the communicator of the controller includes information indicating a malfunction state of the propulsion system. With this arrangement, the information indicating the malfunction state is provided to the operator via the operator fob. Therefore, the operator is able to take timely measures against the malfunction when receiving the malfunction information. In addition, the operator is able to receive the information indicating the malfunction state even if the operator is spaced away from the watercraft maneuvering area. Therefore, the operator is able to consider how to deal with the malfunction before returning to the watercraft maneuvering area. Further, the operator is able to start taking the necessary measures against the malfunction according to the situation before returning to the watercraft maneuvering area or without returning to the watercraft maneuvering area.

In a preferred embodiment of the present invention, the notifier is operable to inform the operator by providing at least one of a buzzer sound, an audible message, display information, or vibrational information to the operator. Of these, the vibrational information is particularly preferred because the information is less liable to be influenced by the ambient environment. Specifically, the vibrational information is highly effective even if noises such as wind sound, engine sound, and speaker sound make it difficult to deliver the audible information. Even if the influences of direct sun light and rain make it difficult to deliver the display information, the vibrational information is highly effective.

Another preferred embodiment of the present invention of the present invention provides a watercraft maneuvering system including an overboard sensor to detect an operator overboard event when a watercraft operator falls overboard from a watercraft, and a controller provided on the watercraft and configured or programmed to control a propulsion system of the watercraft. The controller is configured or programmed to perform a fixed point holding control operation to control the propulsion system so as to maintain the watercraft at a fixed position when the overboard sensor detects the operator overboard event.

With this arrangement, the controller performs the fixed point holding control operation when the operator falls overboard and the overboard sensor detects this overboard event. Thus, the propulsion system is controlled so as to maintain the watercraft at the fixed position and, therefore, the movement of the watercraft is substantially prevented. Since a distance between the watercraft and the overboard operator is less liable to increase, the overboard operator is able to easily return to the watercraft.

In a preferred embodiment of the present invention, the watercraft maneuvering system further includes a portable transmitter to be carried by the operator to transmit a cancellation command to the controller so as to cancel the fixed point holding control operation. Upon reception of the cancellation command from the portable transmitter, the controller is configured or programmed to stop the fixed point holding control operation.

With this arrangement, the operator is able to stop the fixed point holding control operation by remote control with the use of the portable transmitter (a fob or other portable transmitter). Specifically, the operator who has fallen overboard may determine that stopping the fixed point holding control operation makes it difficult to increase the distance between the operator and the watercraft, or makes it easier for the operator to return to the watercraft. Therefore, the operator is able to select the continuation or stopping of the fixed point holding control operation according to a situation. Thus, the operator is able to easily return to the watercraft.

In a preferred embodiment of the present invention, the watercraft maneuvering system further includes a portable transmitter to be carried by the operator and including a watercraft maneuvering input operable by the operator (although another person may actually operate it depending on the circumstances) to transmit a watercraft maneuvering command to the controller according to an operation of the watercraft maneuvering operation input. Upon reception of the watercraft maneuvering command from the portable transmitter, the controller is configured or programmed to control the propulsion system so as to change one or both of the position and the azimuth of the watercraft according to the watercraft maneuvering command.

With this arrangement, the operator is able to control the propulsion system by remote control with the use of the portable transmitter such that the position and/or the azimuth of the watercraft is able to be changed. Therefore, the operator who has fallen overboard is able to properly set the distance between the operator and the watercraft and/or the azimuth of the watercraft according to the situation. For example, the overboard operator is able to move the watercraft by remote control with the use of the portable transmitter so as not to increase the distance between the operator and the watercraft, or so as to reduce the distance between the operator and the watercraft. Further, for example, the overboard operator is able to change the azimuth of the watercraft by remote control with the use of the portable transmitter so as to easily return to the watercraft.

In a preferred embodiment of the present invention, the watercraft maneuvering command is operable to change one or both of a target position and a target azimuth for the fixed point holding control operation. With this arrangement, the position and/or the azimuth of the watercraft is able to be changed by utilizing the function of the fixed point holding control operation so that the remote watercraft maneuvering function is provided without complicating the control operation to be performed by the controller for remote control by the portable transmitter.

Another further preferred embodiment of the present invention provides a watercraft including a hull, a propulsion system provided on the hull, and a watercraft maneuvering system having any of the above-described features.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing the structure of a watercraft according to a preferred embodiment of the present invention by way of example.

FIG. 2 is a block diagram showing the configuration of a watercraft maneuvering system by way of example.

FIG. 3 is a block diagram showing the configuration of an operator fob by way of example.

FIG. 4 is a flowchart showing an overboard detection function of a communication unit by way of example.

FIG. 5 is a flowchart showing an exemplary process to be performed by a watercraft maneuvering controller in relation to overboard information provided from the communication unit.

FIG. 6 is a flowchart showing an exemplary process to be performed by the watercraft maneuvering controller in relation to a watercraft maneuvering operation by remote control with the use of the operator fob.

### DETAILED DESCRIPTION OF THE PREFERRED EMBODIMENTS

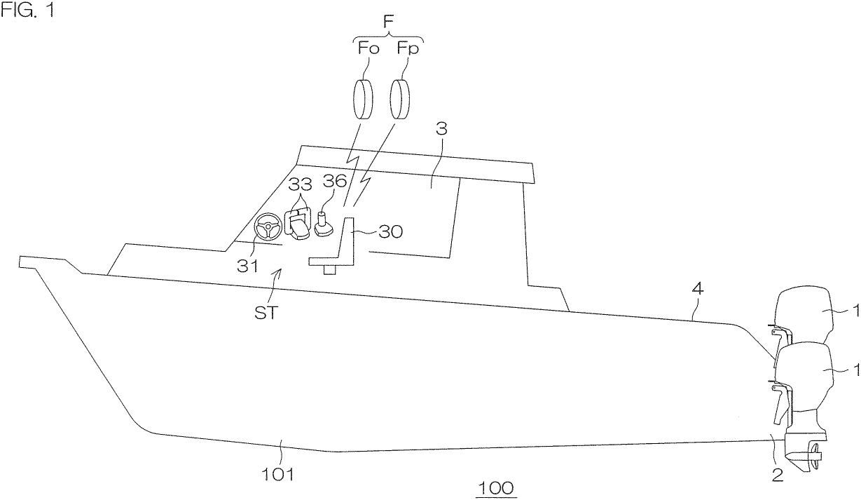

FIG. 1 is a diagram showing the structure of a watercraft 100 according to a preferred embodiment of the present invention by way of example. The watercraft 100 includes a hull 101 and outboard motors 1 provided as exemplary propulsion systems on the hull 101. In this example, two outboard motors 1 are attached to the stern 2 of the hull 101, and arranged side by side transversely of the hull 101.

The hull 101 includes a cabin 3 defined by an outer shell to provide a living space, and a deck 4 provided behind the cabin 3. The watercraft 100 includes a watercraft maneuvering station ST (watercraft maneuvering area). In FIG. 1, the watercraft 100 is illustrated as including a single watercraft maneuvering station ST provided in the cabin 3 by way of example. Alternatively, the watercraft 100 may include a plurality of watercraft maneuvering stations provided on the hull 101.

In the present preferred embodiment, a steering wheel 31, acceleration levers 33, and a joystick 36 are provided in the watercraft maneuvering station ST. The steering wheel 31 is operable to steer the hull 101, and the acceleration levers 33 are operable to provide propulsive force adjustment. The joystick 36 is operable to steer and provide the propulsive force adjustment. A watercraft maneuvering operation is generally performed by operating the steering wheel 31 and the acceleration levers 33. The joystick 36 is mainly used for the watercraft maneuvering operation when the azimuth and/or the position of the watercraft 100 are finely adjusted during docking and undocking, and during berthing at a fishing spot. Of course, the watercraft maneuvering operation with the use of the joystick 36 is not limited to that for the adjustment of the azimuth and/or the position of the watercraft 100 during low-speed traveling, and the joystick 36 may be used for the watercraft maneuvering operation during intermediate-speed and high-speed cruising.

The watercraft maneuvering station ST is an area (i.e., a watercraft maneuvering area) in which a watercraft operator (a user) performs the watercraft maneuvering operation. In the example of FIG. 1, the watercraft maneuvering station ST includes a driver seat 30 on which the operator sits. In some cases, no driver seat 30 is provided in the watercraft maneuvering station ST.

Each of the occupants of the watercraft 100 may carry a fob F. Typically, the fob F is carried on the occupant’s body. The fob F may be wearable, for example, on a wrist, a neck, a belt, or clothing. The occupants are each categorized as the operator or a passenger. The operator fob Fo is to be carried by the operator and a passenger fob Fp is to be carried by the passenger. In the present preferred embodiment, the fobs F are each an electronic device including at least a transmitter function.

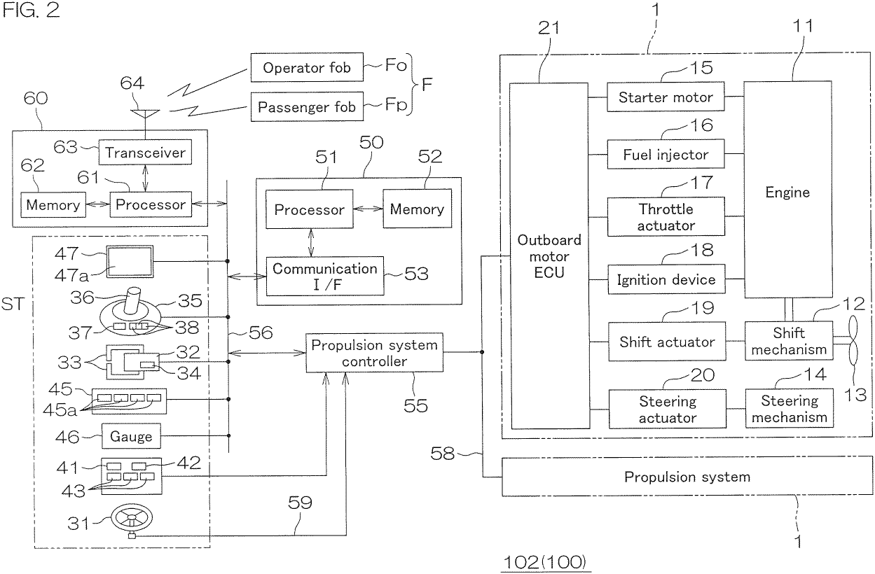

FIG. 2 is a block diagram showing the configuration of a watercraft maneuvering system 102 provided in the watercraft 100 by way of example. The watercraft maneuvering system 102 includes the watercraft maneuvering station ST and the fobs F described above. In the present preferred embodiment, the watercraft maneuvering station ST includes the steering wheel 31, a remote control unit 32, and a joystick unit 35.

The remote control unit 32 includes two acceleration levers 33 respectively corresponding to the two outboard motors 1. The joystick unit 35 includes the joystick 36, which is able to be inclined anteroposteriorly and laterally (i.e., in all 360-degree directions), and is able to be turned (twisted) about its axis. In this example, the joystick unit 35 further includes a joystick button 37. The joystick button 37 is operable by the operator when a control mode (watercraft maneuvering operation mode) utilizing the joystick 36, i.e., a joystick mode, is to be selected. In this example, the joystick unit 35 further includes mode setting buttons 38 operable by the operator to select position/azimuth holding system control modes (examples of a control mode for an automatic watercraft maneuvering operation). More specifically, the mode setting buttons 38 include a mode setting button for a fixed point holding mode (Stay Point™) in which the position and the bow azimuth of the watercraft 100 are maintained, a mode setting button for a position holding mode (Fish Point™) in which the position of the watercraft 100 is maintained but the bow azimuth is not maintained, and a mode setting button for an azimuth holding mode (Drift Point™) in which the bow azimuth is maintained but the watercraft position is not maintained.

The watercraft maneuvering station ST additionally includes a main switch 41, an all-switch 42, separate switches 43, an application panel 45, a gauge 46, a display 47 and the like. The main switch 41 is operable by the operator to turn on and off power supply to the watercraft maneuvering system 102. The all-switch 42 is operable by the operator to start or stop all the outboard motors 1. The separate switches 43 are operable by the operator to individually start or stop the respective outboard motors 1, and the number of the separate switches 43 corresponds to the number of the outboard motors 1. The application panel 45 includes a plurality of switches operable to start application programs, for example, for the automatic watercraft maneuvering operation. Specifically, the application panel 45 may include mode setting switches 45a operable to start course holding system (autopilot system) control modes (other examples of a control mode for the automatic watercraft maneuvering operation). Specifically, the course holding system control modes may include at least one of a bow holding mode (Heading Hold) in which the bow azimuth is maintained during forward traveling, a straight travel holding mode (Course Hold) in which the bow azimuth is maintained and a straight course is maintained during forward traveling, a checkpoint following mode (Track Point) in which a course passing through predetermined checkpoints is followed, and a pattern traveling mode (Pattern Steer) in which a predetermined course pattern is followed. Examples of the course pattern to be followed in the pattern traveling mode include a zig-zag pattern and a spiral pattern. The gauge 46 displays the operation states of the respective outboard motors 1. The display 47 displays various information. In the present preferred embodiment, the display 47 is a multifunctional display including a touch panel 47a provided as an exemplary input device on its surface, thus serving as a man-machine interface.

The watercraft maneuvering system 102 includes a watercraft maneuvering controller 50 for overall system control, and a propulsion system controller 55 to generate command signals to be applied to the outboard motors 1. The watercraft maneuvering controller 50 and the propulsion system controller 55 are connected to each other via an onboard network 56 in a communicable manner. The onboard network 56 is typically a CAN (Control Area Network).

The remote control unit 32 and the joystick unit 35 are connected to the onboard network 56. The application panel 45, the gauge 46 and the display 47 are also connected to the onboard network 56. The steering wheel 31 is connected to the propulsion system controller 55. Specifically, the operation angle signal of the steering wheel 31 is inputted to the propulsion system controller 55 via a steering signal line 59. Further, the main switch 41 is connected to the propulsion system controller 55 to input a power on/off command signal to the propulsion system controller 55. Further, the all-switch 42 and the separate switches 43 are connected to the propulsion system controller 55 to input a propulsion system starting command signal and/or a propulsion system stopping command signal to the propulsion system controller 55.

The propulsion system controller 55 is connected to outboard motor ECUs 21 as controllers of the respective outboard motors 1 (electronic control units, outboard motor controllers) via control signal lines 58. The propulsion system controller 55 transmits a steering command, a propulsive force command and the like to the outboard motors 1. In the present preferred embodiment, the propulsive force command includes a shift command which commands the shift positions of the outboard motors 1, and an output command which commands the outputs (the magnitudes of the propulsive forces) of the outboard motors 1. Further, the propulsion system controller 55 receives various detection signals from the outboard motor ECUs 21 of the respective outboard motors 1. The detection signals to be received preferably include signals indicating the states of the respective outboard motors 1, particularly shift position signals indicating the shift positions of the respective outboard motors 1. The signals indicating the states of the respective outboard motors 1 to be received from the outboard motor ECUs 21 by the propulsion system controller 55 may include signals indicating whether or not the engines 11 of the respective outboard motors 1 are driven (in operation), e.g., engine rotation speed signals indicating the engine rotation speeds.

The outboard motors 1 may each be an engine outboard motor or an electric outboard motor. In FIG. 2, the engine outboard motors are shown by way of example. The outboard motors 1 each include the outboard motor ECU 21, the engine 11, a shift mechanism 12, a propeller 13, a steering mechanism 14 and the like. Power generated by the engine 11 is transmitted to the propeller 13 via the shift mechanism 12. The steering mechanism 14 laterally changes the direction of the propulsive force generated by the outboard motor 1 to turn the body of the outboard motor 1 leftward and rightward with respect to the hull 101 (see FIG. 1). The shift mechanism 12 selects the shift position from a forward shift position, a reverse shift position, and a neutral shift position. With the forward shift position selected, the propeller 13 is rotated in a forward rotation direction by the transmission of the rotation of the engine 11. With the reverse shift position selected, the propeller 13 is rotated in a reverse rotation direction by the transmission of the rotation of the engine 11. With the neutral shift position selected, the transmission of the power between the engine 11 and the propeller 13 is interrupted.

The outboard motors 1 each further include a starter motor 15, a fuel injector 16, a throttle actuator 17, an ignition device 18, a shift actuator 19, a steering actuator 20 and the like, which are controlled by the outboard motor ECU 21. The starter motor 15 is an electric motor which starts the engine 11. The fuel injector 16 injects a fuel to be combusted in the engine 11. The throttle actuator 17 is an electric actuator (typically including an electric motor) which actuates the throttle valve of the engine 11. The ignition device 18 ignites a mixed gas in the combustion chamber of the engine 11, and typically includes an ignition plug and an ignition coil. The shift actuator 19 actuates the shift mechanism 12. The steering actuator 20 is a drive source for the steering mechanism 14, and typically includes an electric motor. The steering actuator 20 may include a hydraulic device of an electric pump type.

The watercraft maneuvering controller 50 includes a processor 51 (arithmetic unit), a memory 52, a communication interface 53 and the like. The watercraft maneuvering controller 50 functions as various functional units by executing a program stored in the memory 52. Various data is stored in the memory 52. The onboard network 56 is connected to the communication interface 53. Thus, the watercraft maneuvering controller 50 is able to communicate with the propulsion system controller 55. Further, the watercraft maneuvering controller 50 is able to communicate with the remote control unit 32 and the joystick unit 35. The watercraft maneuvering controller 50 communicates with the gauge 46 via the onboard network 56 to transmit display data to the gauge 46. Further, the watercraft maneuvering controller 50 communicates with the display 47 via the onboard network 56 to receive an input signal from the touch panel 47a and to transmit a display command signal to the display 47.

The watercraft maneuvering system 102 further includes a communication unit 60 which communicates with the fobs F. The communication unit 60 is connected to the watercraft maneuvering controller 50 via the onboard network 56. As described above, the fobs F include the operator fob Fo to be carried by the operator, and the passenger fob(s) Fp to be carried by the passenger(s). The communication unit 60 includes, for example, a processor 61, a memory 62, and a transceiver 63. For example, the communication unit 60 transmits a query signal to all the fobs F at a predetermined time interval (e.g., at an interval of 1 second). The fobs F each receive the query signal, and respectively output response signals. The response signals are received by the communication unit 60. The response signals outputted from the fobs F respectively include IDs (identification information) for identification of the fobs F. Thus, the communication unit 60 is able to identify the response signals outputted from the respective fobs F.

The IDs of the fobs F to be carried by the occupants are preliminarily registered in the memory 62 of the communication unit 60. The processor 61 of the communication unit 60 compares the IDs received from the respective fobs F by the transceiver 63 (hereinafter referred to as “reception IDs”) with the IDs registered in the memory 62 (hereinafter referred to as “registration IDs”). Based on the results of the comparison, the processor 61 checks whether or not all the reception IDs corresponding to the registration IDs are received. Based on the check result, the processor 61 determines whether or not an overboard event has occurred. If any of the reception IDs corresponding to the registration IDs is absent, there is a possibility that the overboard event has occurred. Therefore, the processor 61 transmits overboard information indicating the occurrence of the overboard event to the watercraft maneuvering controller 50. The overboard information includes, for example, a registration ID corresponding to the absent reception ID. The ID of the operator fob Fo and the ID of the passenger fob Fp are able to be registered in the memory 62 in a distinguishable manner. Therefore, the processor 61 is able to distinguish an operator overboard event from a passenger overboard event, and the overboard information may include information distinguishably indicating the operator overboard event or the passenger overboard event. In the present preferred embodiment, the communication unit 60 thus functions as an overboard sensor. A reference character 64 denotes the antenna of the transceiver 63.

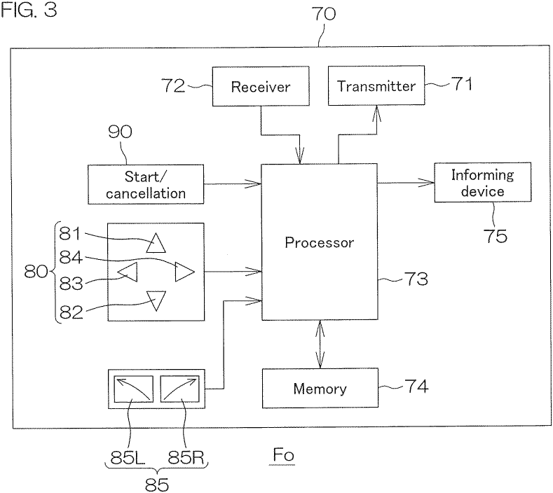

FIG. 3 is a block diagram showing the configuration of the operator fob Fo by way of example. The operator fob Fo includes a transmitter 71, a receiver 72, a processor 73, a memory 74, and an informing device 75 (notifier), which are accommodated in a portable water-proof housing 70.

The operator fob Fo further includes an operation element (input) operable to remotely control the watercraft maneuvering system 102 (particularly, the outboard motors 1). Specifically, the operator fob Fo includes a start/cancellation button 90 (an example of the cancellation operation element or input) operable to start and cancel the fixed point holding control operation. The operator fob Fo may include a start button operable to command the start of the fixed point holding control operation, and a cancellation button provided separately from the start button operable to cancel (stop) the fixed point holding control operation. At least the cancellation button is preferably provided although the start button may be omitted. The operator fob Fo further includes watercraft maneuvering buttons (examples of the watercraft maneuvering operation element or input) operable to apply a watercraft maneuvering command to the communication unit 60 of the watercraft maneuvering system 102. Specifically, the watercraft maneuvering buttons include position change buttons 80 and azimuth change buttons 85. The position change buttons 80 are operable to change the position of the watercraft 100 and include, for example, buttons 81 to 84 operable to change the position of the watercraft 100 forward, rearward, leftward, and rightward, respectively. The azimuth change buttons 85 are operable to change the azimuth of the watercraft 100 and include, for example, a right turn button 85R and a left turn button 85L.

The processor 73 operates according to a program stored in the memory 74.

Specifically, the processor 73 operates to transmit the response signal from the transmitter 71 to the communication unit 60 when the receiver 72 receives the query signal from the communication unit 60 of the watercraft maneuvering system 102. The response signal is used for an overboard detection process to be performed by the communication unit 60. The response signal includes the ID of the operator fob Fo.

In response to the operation of the start/cancellation button 90, the processor 73 transmits a fixed point holding start/cancellation command from the transmitter 71 toward the communication unit 60 of the watercraft maneuvering system 102. Where the start button and the cancellation button are separately provided, the processor 73 issues a fixed point holding start command in response to the operation of the start button, and issues a fixed point holding cancellation command in response to the operation of the cancellation button.

Further, the processor 73 transmits the watercraft maneuvering command from the transmitter 71 to the communication unit 60 of the watercraft maneuvering system 102 in response to the operation of any of the watercraft maneuvering buttons. More specifically, the processor 73 outputs a position change command from the transmitter 71 to change the position of the watercraft 100 when any of the position change buttons 80 is operated. Further, the processor 73 outputs an azimuth change command from the transmitter 71 to turn the watercraft 100 when any of the azimuth change buttons 85 is operated. Any of the position change buttons 80 may be operated simultaneously with any of the azimuth change buttons 85. In this case, the processor 73 outputs both the position change command and the azimuth change command from the transmitter 71.

In the present preferred embodiment, the operator fob Fo is an example of a portable device which transmits the fixed point holding cancellation command and the watercraft maneuvering command to the communication unit 60.

In the present preferred embodiment, the operator fob Fo is configured to receive watercraft maneuvering information of the watercraft 100 from the communication unit 60 and provide the information to the operator. Specifically, the information to be provided includes information indicating the operation states of the outboard motors 1, more specifically, malfunction information. If the watercraft maneuvering controller 50 is informed of the malfunction of the outboard motors 1 by the propulsion system controller 55, the watercraft maneuvering controller 50 transmits the malfunction information indicating the malfunction from the communication unit 60 to the operator fob Fo. The malfunction information is received by the receiver 72 of the operator fob Fo. Upon the reception of the malfunction information, the processor 73 actuates the informing device 75 to provide the malfunction information to the operator. The informing device 75 is, e.g., an alarm, that is able to generate at least one of a buzzer sound, an audible message, display information, or vibrational information. Particularly, the vibrational information is preferred because the information is less liable to be influenced by the ambient environment. Specifically, the vibrational information is highly effective even if noises such as wind sound, engine sounds, and speaker sound make it difficult to deliver the audible information. Even if the influences of direct sun light and rain make it difficult to deliver the display information, the vibrational information is highly effective.

The informing device 75 is configured to provide at least the information of the occurrence of the malfunction to the operator. The informing device 75 is preferably configured to provide information indicating a malfunction state to the operator. The information indicating the malfunction state may be information indicating a malfunction type, a malfunctioning part or the like.

The passenger fob Fp may have substantially the same configuration as the operator fob Fo. However, the passenger fob Fp preferably have none of the operation elements or inputs for remote control nor the corresponding functions. The passenger fob Fp need not include the informing device 75. That is, the passenger fob Fp may have a configuration and a function to detect a passenger overboard event, but preferably has neither the configuration nor the function for the watercraft maneuvering operation.

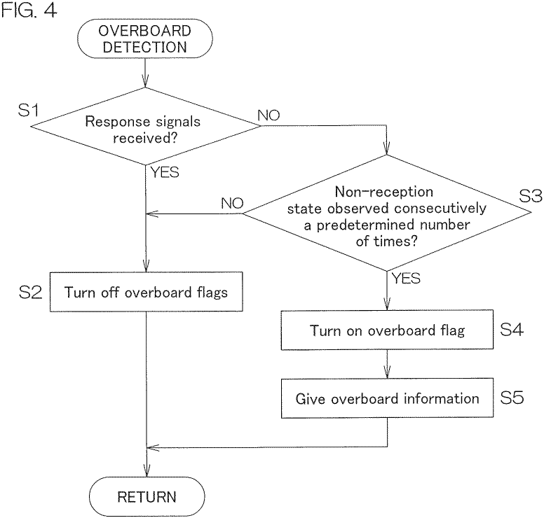

FIG. 4 is a flowchart showing the overboard detection function of the communication unit 60 provided on the hull 101 (the function of the overboard sensor) by way of example. The processor 61 of the communication unit 60 periodically transmits the query signal to all the fobs F corresponding to the registration IDs, and performs a process shown in FIG. 4 every time it transmits the query signal. The processor 61 determines whether or not response signals are received from all the fobs F (Step S1). If the response signals are received from all the fobs F (YES in Step S1), the processor 61 turns off overboard flags for all the fobs F (Step S2), and records in the memory 62 that none of the occupants carrying the fobs F are overboard. If no response signal is received from a specific one of the fobs F (NO in Step S1), the processor 61 determines whether the non-reception state of the specific fob F is observed consecutively a predetermined number of times (Step S3). If the non-reception state of the specific fob F is not observed consecutively the predetermined number of times (NO in Step S3), the processor 61 turns off all the overboard flags (Step S2). If the non-reception state of the specific fob F is observed consecutively the predetermined number of times (YES in Step S3), the processor 61 turns on an overboard flag for the specific fob F (Step S4), and records in the memory 62 that an occupant carrying the specific fob F is overboard. Further, the processor 61 transmits the overboard information to the watercraft maneuvering controller 50 (Step S5). As described above, the overboard information includes the registration ID of the specific fob F and the fob type information indicating whether the specific fob F is the operator fob Fo or the passenger fob Fp.

The reach range of the query signal to be transmitted to the fobs F by the communication unit 60 and the reach range of the response signal to be transmitted to the communication unit 60 by each of the fobs F are preferably set so that the communication unit 60 is able to communicate with the fobs F when the fobs F are present on the watercraft 100. Thus, the overboard flags for the fobs F present on the watercraft 100 are able to be turned off.

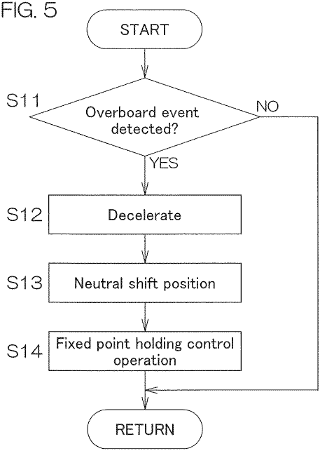

FIG. 5 is a flowchart showing an exemplary process to be performed by the watercraft maneuvering controller 50 in relation to the overboard information provided from the communication unit 60. The watercraft maneuvering controller 50 repeatedly performs the process in a predetermined control cycle. If the watercraft maneuvering controller 50 receives the overboard information from the communication unit 60 to detect the overboard event (YES in Step S11), the watercraft maneuvering controller 50 performs a propulsive force nullifying control operation to cancel the propulsive forces of all the outboard motors 1 (Steps S12, S13). After the propulsive force nullifying control operation, the watercraft maneuvering controller 50 performs the fixed point holding control operation (Step S14).

In the propulsive force nullifying control operation, the generation of the propulsive forces of all the outboard motors 1 is stopped. In the present preferred embodiment, the propulsive force nullifying control operation includes a deceleration control operation to be performed to reduce the rotation speeds of the engines 11 of the outboard motors 1 (Step S12), and a shift control operation to be performed after the deceleration control operation (Step S13).

In the deceleration control operation, the rotation speeds of the engines 11 are each gradually reduced (e.g., to an idling rotation speed) in order to smoothly stop the watercraft 100 while preventing abrupt deceleration of the watercraft 100. Therefore, the deceleration rate of the engine rotation speed in the deceleration control operation is set to a value that provides smooth deceleration of the watercraft 100. A command for this deceleration control operation is applied from the watercraft maneuvering controller 50 to the propulsion system controller 55. Then, the propulsion system controller 55 time-serially applies output commands to the outboard motors 1 for the commanded deceleration control operation.

In the shift control operation (Step S13), the shift positions of all the outboard motors 1 are each changed to the neutral shift position. After the deceleration control operation (Step S12), the watercraft maneuvering controller 50 applies a shift command to the propulsion system controller 55 so as to change the shift positions of all the outboard motors 1 to the neutral shift positions (Step S13). Accordingly, the propulsion system controller 55 transmits the shift command from the watercraft maneuvering controller 50 to the outboard motor ECUs 21. Thus, the engine rotation speeds and the shift positions of the outboard motors 1 are controlled. Thus, the watercraft 100 is smoothly decelerated and, with the shift positions of the outboard motors 1 changed to the neutral shift positions, the watercraft 100 is brought into a state in which no propulsive force is applied thereto.

In the fixed point holding control operation (Step S14), specifically, the fixed point holding mode (Stay Point™) in which the position and the bow azimuth of the watercraft 100 are maintained may be selected. The watercraft maneuvering controller 50 automatically switches the control mode to the fixed point holding mode (Step S14). Then, the watercraft maneuvering controller 50 sets the current position of the watercraft 100 to a target position for the fixed point holding control operation, and sets the current azimuth of the watercraft 100 to a target azimuth for the fixed point holding control operation. Therefore, the fixed point holding control operation is automatically started to maintain the position and the azimuth of the watercraft 100 observed at the end of the propulsive force nullifying control operation (Steps S12, S13). The watercraft maneuvering controller 50 records the position and the azimuth of the watercraft 100 observed when the information of the overboard detection is provided thereto, and sets the position and the azimuth thus recorded (i.e., the position and the azimuth observed when the overboard event is detected) as the target position and the target azimuth, respectively, for the fixed point holding control operation.

The watercraft maneuvering controller 50 performs neither the propulsive force nullifying control operation nor the fixed point holding control operation if the overboard event is not detected (NO in Step S11).

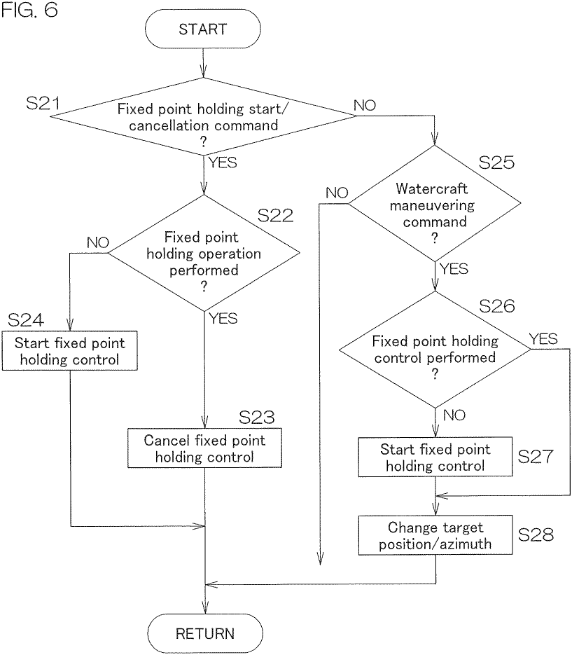

FIG. 6 is a flowchart showing an exemplary process to be performed by the watercraft maneuvering controller 50 in relation to the watercraft maneuvering operation by remote control with the use of the operator fob Fo. If the operator overboard event is detected, the fixed point holding control operation is automatically started as described above. After the start of the fixed point holding control operation, the watercraft maneuvering controller 50 determines whether or not the fixed point holding start/cancellation command is applied (Step S21). If the start/cancellation button 90 of the operator fob Fo is operated, as described above, the fixed point holding start/cancellation command is transmitted from the operator fob Fo. Then, the fixed point holding start/cancellation command is received by the communication unit 60, and is applied to the watercraft maneuvering controller 50. Upon reception of the fixed point holding start/cancellation command, the watercraft maneuvering controller 50 determines whether or not the fixed point holding control operation is performed (Step S22). If the fixed point holding control operation is performed (YES in Step S22), the watercraft maneuvering controller 50 cancels the fixed point holding control operation (Step S23). If the fixed point holding control operation is not performed (NO in Step S22), the watercraft maneuvering controller 50 starts the fixed point holding control operation (Step S24). Thus, the fixed point holding control operation is able to be stopped and restarted by the remote control with the use of the operator fob Fo.

On the other hand, the watercraft maneuvering command transmitted from the operator fob Fo may be received by the communication unit 60 when the operator overboard event is detected. If the received watercraft maneuvering command is applied to the watercraft maneuvering controller 50 (YES in Step S25), the watercraft maneuvering controller 50 determines whether or not the fixed point holding control operation is performed (Step S26). If the fixed point holding control operation is not performed, the fixed point holding control operation is started (Step S27). Further, the watercraft maneuvering controller 50 changes the target position and/or the target azimuth for the fixed point holding control operation according to the watercraft maneuvering command (Step S28). The watercraft maneuvering controller 50 applies a steering command and a propulsive force command to the propulsion system controller 55 to achieve the target position and/or the target azimuth thus changed. The propulsion system controller 55 correspondingly controls the outboard motors 1. Thus, at least one of the position or the azimuth of the watercraft 100 is changed such that the watercraft 100 is controlled to be moved to the position or the azimuth according to the watercraft maneuvering command applied from the operator fob Fo.

In a preferred embodiment, as described above, if the operator carrying the operator fob Fo falls overboard and this operator overboard event is detected by the overboard detection function of the communication unit 60, the watercraft maneuvering controller 50 automatically starts the fixed point holding control operation. Thus, the outboard motors 1 are controlled so as to maintain the watercraft 100 at a fixed position such that the movement of the watercraft 100 is substantially prevented. Since a distance between the watercraft 100 and the overboard operator is less liable to increase, the overboard operator is able to easily return to the watercraft 100.

In a preferred embodiment, if the operator overboard event is detected, the watercraft maneuvering controller 50 performs the deceleration control operation to decelerate the watercraft 100 (specifically, to reduce the engine rotation speeds), and then starts the fixed point holding control operation. Thus, the watercraft 100 is able to be smoothly decelerated, and then maintained at the fixed position.

In a preferred embodiment, the outboard motors 1 are engine propulsion systems including the engines 11. After the deceleration control operation, the shift positions of the outboard motors 1 are controlled to be changed to the neutral shift positions such that the power transmission paths between the engines 11 and the propellers 13 are cut off. Thereafter, the fixed point holding control operation is started. By changing the shift positions of the outboard motors 1 to the neutral shift positions (in the disengaged state) after the deceleration control operation, the watercraft 100 is able to be smoothly decelerated, and then brought into a propulsive force non-generating state. Thereafter, the movement of the watercraft 100 is able to be substantially prevented by the fixed point holding control operation.

In a preferred embodiment, the watercraft maneuvering controller 50 is able to communicate with the operator fob Fo via the communication unit 60. That is, the communication unit 60 doubles as the communication unit of the watercraft maneuvering controller 50. The operator fob Fo includes the start/cancellation button 90 as the cancellation operation element or input. If the start/cancellation button 90 is operated, the fixed point holding start/cancellation command is transmitted toward the communication unit 60. If the fixed point holding control operation is performed, the watercraft maneuvering controller 50 regards the fixed point holding start/cancellation command as the fixed point holding cancellation command. If the fixed point holding control operation is not performed, the watercraft maneuvering controller 50 regards the fixed point holding start/cancellation command as the fixed point holding start command. Therefore, the operator who has fallen overboard is able to stop or restart the fixed point holding control operation according to the situation by remote control with the use of the operator fob Fo. Specifically, the overboard operator may determine that stopping the fixed point holding control operation makes it difficult to increase the distance between the operator and the watercraft 100 or makes it easier for the operator to return to the watercraft 100. Therefore, the operator is able to select the continuation or the stopping of the fixed point holding control operation according to the situation by remote control. Thus, the operator is able to easily return to the watercraft 100.

In a preferred embodiment, as described above, the communication unit 60 is shared by the communication unit for the remote watercraft maneuvering operation and the communication unit for the overboard detection function, but these communication units may be separately provided.

In a preferred embodiment, the operator fob Fo includes the position change buttons 80 and the azimuth change buttons 85 as the watercraft maneuvering buttons, and transmits the watercraft maneuvering command to the communication unit 60 in response to the operation of any of these buttons. The communication unit 60 transfers the received watercraft maneuvering command to the watercraft maneuvering controller 50. Upon reception of the watercraft maneuvering command, the watercraft maneuvering controller 50 controls the outboard motors 1 so as to change one or both of the position and the azimuth of the watercraft 100. Therefore, the operator who has fallen overboard with the operator fob Fo is able to properly set the distance between the operator and the watercraft 100 and/or the azimuth of the watercraft 100 according to the situation. For example, the operator is able to move the watercraft 100 by remote control with the use of the operator fob Fo so as not to increase the distance between the operator and the watercraft 100 or so as to reduce the distance between the operator and the watercraft 100. For example, the operator is able to change the azimuth of the watercraft 100 by the remote control with the use of the operator fob Fo so as to easily return to the watercraft.

In a preferred embodiment, more specifically, the watercraft maneuvering controller 50 changes one or both of the target position and the target azimuth for the fixed point holding control operation according to the watercraft maneuvering command. Thus, the position and/or the azimuth of the watercraft 100 is able to be changed by utilizing the function of the fixed point holding control operation. Therefore, the remote watercraft maneuvering function is provided without complicating the control operation to be performed by the watercraft maneuvering controller 50 for remote control by the operator fob Fo.

In a preferred embodiment, the watercraft maneuvering controller 50 communicates with the operator fob Fo via the communication unit 60 to transmit the watercraft maneuvering information of the watercraft 100 (particularly, the malfunction information) to the operator fob Fo. Then, the operator fob Fo provides the received information to the operator from the informing device 75. Thus, the watercraft maneuvering information of the watercraft 100 (particularly, the malfunction information) is able to be provided to the operator via the operator fob Fo by wireless communications with the use of the operator fob Fo. Therefore, even if the operator is spaced away from the watercraft maneuvering station ST, for example, the operator is able to know the watercraft maneuvering information of the watercraft 100. Therefore, the watercraft maneuvering system 102 permits flexible behavior of the operator on the watercraft 100.

Further, the malfunction information is provided to the operator via the operator fob Fo such that the operator is able to take timely measures against the malfunction when receiving the malfunction information. In addition, the operator is able to receive the information indicating the malfunction state even if the operator is spaced away from the watercraft maneuvering station ST. Therefore, the operator is able to consider how to deal with the malfunction before returning to the watercraft maneuvering station ST. Further, the operator is able to start taking the necessary measures against the malfunction according to the situation before returning to the watercraft maneuvering station ST or without returning to the watercraft maneuvering station ST.

While preferred embodiments of the present invention have thus been described above, the present invention may be embodied in some other ways as will be described below by way of example.

In a preferred embodiment described above, the outboard motors 1 each including the engine as a prime mover are used as the propulsion systems, but propulsion systems of different structure may be used. For example, electric propulsion systems each including an electric motor as the prime mover may be used as the propulsion systems. Besides the outboard motors 1, the propulsion systems may be inboard motors, inboard/outboard motors, jet propulsion systems, or any other propulsion systems. In the electric propulsion systems, the nullification of the propulsive forces is typically achieved by stopping the electric motors.

In a preferred embodiment described above, the two propulsion systems (two outboard motors 1) are provided on the stern 2 by way of example, but the number and the positions of the propulsion systems are not limited to those. Alternatively, a single propulsion system or three or more propulsion systems may be provided on the stern 2. Further, a bow thruster may be provided around the bow.

In a preferred embodiment described above, the operator overboard event is detected by using the operator fob Fo which wirelessly communicates with the communication unit 60 provided on the watercraft 100. Alternatively, the operator overboard event may be detected by using a lanyard cable which connects the operator to a lanyard switch provided in the watercraft maneuvering station ST. Even in this case, the distance between the watercraft 100 and the overboard operator is made less liable to increase by automatically starting the fixed point holding control operation in response to the detection of the operator overboard event.

In a preferred embodiment described above, the operator fob Fo for the detection of the overboard event has a function as the portable device for the remote watercraft maneuvering operation, but the watercraft maneuvering system may be designed to perform the remote watercraft maneuvering operation with the use of a portable device separate from the operator fob Fo.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A watercraft maneuvering system comprising:
an operator fob to be carried by an operator of a watercraft;
an overboard sensor provided on the watercraft, including a communicator to wirelessly communicate with the operator fob, to detect an operator overboard event based on a state of communication between the operator fob and the communicator; and
a controller provided on the watercraft and configured or programmed to control a propulsion system of the watercraft; wherein
the controller is configured or programmed to perform a fixed point holding control operation to control the propulsion system so as to maintain the watercraft at a fixed position when the overboard sensor detects the operator overboard event.

2. The watercraft maneuvering system according to claim 1, wherein, if the overboard sensor detects the operator overboard event, the controller is configured or programmed to perform a deceleration control operation to control the propulsion system so as to decelerate the watercraft, and to perform the fixed point holding control operation after the deceleration control operation.

3. The watercraft maneuvering system according to claim 2, wherein
the propulsion system includes an engine, a propeller to be driven by the engine, and a clutch provided in a power transmission path between the engine and the propeller; and
the controller is configured or programmed to perform the deceleration control operation if the overboard sensor detects the operator overboard event and, after the deceleration control operation, to move the clutch to a disengaged state, and then to perform the fixed point holding control operation.

4. The watercraft maneuvering system according to claim 1, wherein
the controller includes a communicator to communicate with the operator fob;
the operator fob includes a cancellation operation input operable by the operator, and a transmitter to transmit a fixed point holding cancellation command to the communicator of the controller according to an operation of the cancellation operation input; and
if the communicator of the controller receives the fixed point holding cancellation command from the operator fob, the controller is configured or programmed to stop the fixed point holding control operation.

5. The watercraft maneuvering system according to claim 1, wherein
the controller includes a communicator to communicate with the operator fob;
the operator fob includes a watercraft maneuvering operation input operable by the operator, and a transmitter to transmit a watercraft maneuvering command to the communicator of the controller according to an operation of the watercraft maneuvering operation input; and
if the communicator of the controller receives the watercraft maneuvering command from the operator fob, the controller is configured or programmed to control the propulsion system so as to change at least one of a position or an azimuth of the watercraft according to the watercraft maneuvering command.

6. The watercraft maneuvering system according to claim 5, wherein the watercraft maneuvering command is operable to change at least one of a target position or a target azimuth for the fixed point holding control operation.

7. The watercraft maneuvering system according to claim 1, wherein
the controller includes a communicator to communicate with the operator fob to transmit watercraft maneuvering information of the watercraft to the operator fob; and
the operator fob includes a receiver to receive the watercraft maneuvering information transmitted from the communicator of the controller, and an notifier to provide the information received by the receiver to the operator.

8. The watercraft maneuvering system according to claim 7, wherein the watercraft maneuvering information to be transmitted to the operator fob by the communicator of the controller includes information indicating a malfunction state of the propulsion system.

9. The watercraft maneuvering system according to claim 7, wherein the notifier informs the operator by providing at least one of a buzzer sound, an audible message, display information, or vibrational information to the operator.

10. A watercraft maneuvering system comprising:
an overboard sensor to detect an operator overboard event when a watercraft operator falls overboard from a watercraft; and
a controller provided on the watercraft and configured or programmed to control a propulsion system of the watercraft; wherein
the controller is configured or programmed to perform a fixed point holding control operation to control the propulsion system so as to maintain the watercraft at a fixed position when the overboard sensor detects the operator overboard event.

11. The watercraft maneuvering system according to claim 10, further comprising:
a portable transmitter to be carried by the operator to transmit a cancellation command to the controller so as to cancel the fixed point holding control operation; wherein
upon reception of the cancellation command from the portable transmitter, the controller is configured or programmed to stop the fixed point holding control operation.

12. The watercraft maneuvering system according to claim 10, further comprising:
a portable transmitter to be carried by the operator and including a watercraft maneuvering operation input operable by the operator to transmit a watercraft maneuvering command to the controller according to an operation of the watercraft maneuvering operation input; wherein
upon reception of the watercraft maneuvering command from the portable transmitter, the controller is configured or programmed to control the propulsion system so as to change at least one of a position or an azimuth of the watercraft according to the watercraft maneuvering command.

13. The watercraft maneuvering system according to claim 12, wherein the watercraft maneuvering command is operable to change at least one of a target position or a target azimuth for the fixed point holding control operation.

14. A watercraft comprising:
a hull;
a propulsion system provided on the hull; and
a watercraft maneuvering system according to claim 1.

15. A watercraft comprising:
a hull;
a propulsion system provided on the hull; and
a watercraft maneuvering system according to claim 10.
